(19) United States
(12) Patent Application Publication
(10) Pub. No.: US 2021/0294909 A1
(43) Pub. Date: Sep. 23, 2021

(54) REAL-TIME ESCALATION AND MANAGING OF USER PRIVILEGES FOR COMPUTER RESOURCES IN A NETWORK COMPUTING ENVIRONMENT

(71) Applicant: SuperUser Software, Inc., Miami, FL (US)

(72) Inventors: David Sibiski, Jr., Rio Grande, PR (US); Todd Jones, Rio Grande, PR (US)

(73) Assignee: SuperUser Software, Inc., Miami, FL (US)

(21) Appl. No.: 17/255,405

(22) PCT Filed: Jun. 21, 2019
(86) PCT No.: PCT/US2019/038475

§ 371 Date: Dec. 22, 2020

Related U.S. Application Data
(60) Provisional application No. 62/689,086, filed on Jun. 23, 2018.

(51) Int. Cl. G06F 21/60; H04L 29/08; G06F 9/54; G06F 21/53; G06F 21/62

(52) U.S. Cl. CPC G06F 21/604; H04L 67/10; G06F 9/541; G06F 2221/2145; G06F 21/62; H04L 67/20; G06F 21/53

(57) ABSTRACT

A computer-enabled system and method that provides for real-time escalation of user privileges and real-time creation of rules for managing requests for privilege on a computer resource by a local or remote Approver, System Administrator, organization, or other responsible entity is disclosed. A computer is monitored for privilege restriction events which notifies a local or remote Approver, System Administrator, organization or other responsible entity. Upon detection of such an event, the system determines the identity of the trigger item that initiated the event. Based on information pertaining to the initiating trigger item along with other computer system state information an Approver remotely evaluates the computer along with the request(s) for privilege and approves or denies the request(s) in real-time. Information of the privilege request, approver's response, and resultant actions can be made available to other systems for ticketing, tracking, and billing for the transactional evaluation of the privilege event.

### SUMMARY OF THE INVENTION

The invention relates to a computer-enabled system and method that provides for real-time escalation of user privileges and real-time creation of rules for managing requests for privilege on a computer resource based on verification by a remote Approver, System Administrator, organization, or other responsible entity. In one embodiment a computer is monitored for requests for privilege (i.e. computer operating system requests for password credential input, or in the case of Windows computers a “UAC” (User Account Control) input dialog box or notification) by a remote Approver, System Administrator, organization or other responsible entity. Upon detection of such a request, the system determines the identity of the process that initiated the event. The information pertaining to the initiating process along with other computer system state information is passed to an Approver Notification Interface which allows Approvers to remotely evaluate the computer along with the request(s) for privilege. The request(s) can be Approved/Denied in real-time and optionally a rule can be created to be applied to future processes matching the Approver's preferences. The system automatically approves or denies requests for privilege for processes that match rules based on criteria that were previously defined by either the Approver, or the System Administrator.

The system facilitates Real-Time creation of Approval/Denial rules by a remote Approver, System Administrator, organization, or responsible entity. Additionally, application of Approval/Denial rules previously established by the Approver or System Administrator can be enforced remotely over a network and independent of physical location, membership in an Active Directory (AD) environment, or of AD Group Policy Objects (GPOs).

When the request for privilege is approved in Real-Time or matches a pre-existing rule for approval the system either elevates using the Operating System, an available 3^{rd} party tool for the application with the matching rule, or generates an admin credential that is input into the specific instance of the request for privilege, process, or approved application.

The system and method of the invention does not require prior knowledge of any application/process/or activity by an Approver of an existing “rule” to apply and enforce privilege elevation rules. Privilege elevation rules can be established in real time by facilitating communication with technical personnel who administer the computer system. The system and method of the invention automates communication between the end user of a computer and an Approver in real-time regarding privilege requests and events and facilitates the extension of that communication to a plurality of 3^{rd} party ticketing systems or other systems for purposes including but not limited to documentation, billing, and compliance. Each privilege request and event can be referenced by external systems uniquely via the system API making it possible to execute remote approval or denial decisions, get notifications, or gather other system information about, or pertaining to privilege requests and events happening locally on the users managed computer. These actions can be carried out directly with the Approver Notification Interface and System Administrator Configuration Portal or from within a 3^{rd} party connected administrative or ticketing system connecting via the system API. The system and method can be implemented independently of an organization's GPO or AD such that privilege elevation rules can be updated and enforced across a variety of connected machines regardless of their affiliation to a particular network. The system and method can be applied to groups of machines based on definable organizational requirements using information stored on the machine independently of GPO/AD. Further, the system and method can be defined in multitenant organizational groups giving service providers or administrators of large environments the ability to manage systems on disparate companies, networks, system type, connection type, operating system, or location.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative representation of a logical embodiment of invention components according to one embodiment of the invention.

FIG. 2 depicts a flow diagram for the Request for Privilege Evaluation process according to one embodiment of the invention.

FIG. 3 depicts a flow diagram of a sub-process on Local Agent Engine when the Trigger Handler Routing is to process and apply rules using the Live Mode Operational Mode according to one embodiment of the invention.

FIG. 4 depicts a flow diagram of the Real-Time Privilege Evaluation Process and application of existing rules according to one embodiment of the invention.

FIG. 5 depicts a sub-process on Local Agent Engine, Cloud Services Engine, and Approver Notification Interface when a 1-Time denial for a Trigger Item is selected during the Real-Time Privilege Evaluation Process according to one embodiment of the invention.

FIG. 6 depicts a sub-process on Approver Notification Interface and Cloud Services Engine when Approval with Rule Creation for a Trigger Item is selected during the Real-Time Privilege Evaluation Process according to one embodiment of the invention.

FIG. 7 depicts a sub-process on Approver Notification Interface and Cloud Services Engine when 1-Time Approval for a Trigger Item is selected during the Real-Time Privilege Evaluation Process according to one embodiment of the invention.

FIG. 8 depicts a sub-process on Local Agent Engine, Approver Notification Interface, and Cloud Services Engine when Denial with a Rule for a Trigger Item is selected during the Real-Time Privilege Evaluation Process according to one embodiment of the invention.

FIG. 9 depicts a sub-process on Local Agent Engine, Approver Notification Interface, and Cloud Services Engine when Approval for a User's Privilege Role is selected during the Real-Time Privilege Evaluation Process according to one embodiment of the invention

FIG. 10 depicts a flow diagram of a sub-process on Local Agent Engine when the Trigger Handler Routing is to process and apply rules using the Policy Mode Operational Mode according to one embodiment of the invention.

FIG. 11 depicts a flow diagram of a sub-process on Local Agent Engine when the Trigger Handler Routing is to process and apply rules using the Technician Mode Operational Mode according to one embodiment of the invention.

FIG. 12 depicts a flow diagram of a sub-process on Local Agent Engine for the Trigger Handler Routing and of application of existing rules according to one embodiment of the invention.

FIG. 13 depicts a flow diagram of a sub-process on Local Agent Engine for the Out of Band Offline Approval process and application of existing rules according to one embodiment of the invention.

FIG. 14 depicts a sub-process on Local Agent Engine when a Trigger Identifier (TID) being processed is identified by the Trigger Handler Routing as a Trigger Item of an Operating System Request for Privilege according to one embodiment of the invention.

FIG. 15 depicts a sub-process on Local Agent Engine when a Trigger Identifier (TID) being processed is identified by the Trigger Handler Routing as a Trigger Type of Application Request for Privilege according to one embodiment of the invention.

FIG. 16 depicts a sub-process on Local Agent Engine when a Trigger Identifier (TID) being processed is identified by the Trigger Handler Routing as a Trigger Type of something other than an Operating System Request or Application Request for Privilege.

### DETAILED DESCRIPTION OF THE INVENTION

Illustrative embodiments will now be described more fully herein with reference to the accompanying drawings, in which embodiments are shown. The teachings may be practiced within any type of networked computing environment and is not limited by any embodiments. These embodiments are provided to convey the scope of the disclosure to those skilled in the art. In the description, details of well-known features and techniques may be omitted.

As indicated, the invention relates to a system and method that provides for real-time escalation of user privileges and real-time creation of rules for managing requests for privilege on a computer resource based on verification by a remote Approver, System Administrator, organization, or other responsible entity.

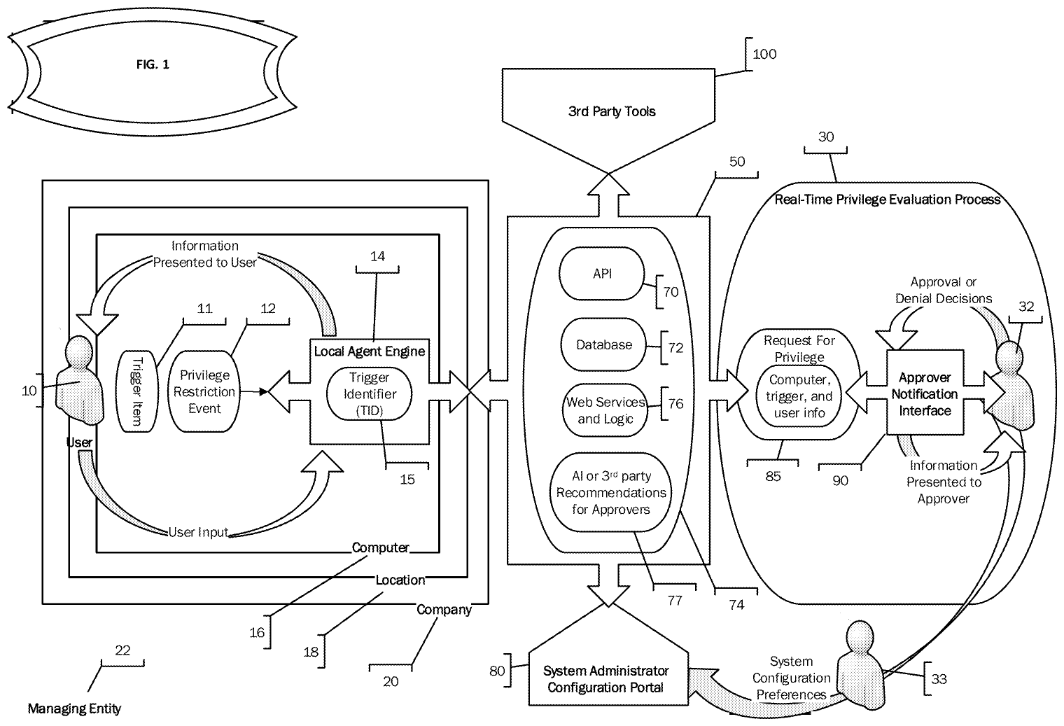

Turning to the figures, FIG. 1 depicts a system diagram describing the functionality of the system according to an embodiment of the invention. One or more Computers 16 are loaded with a Local Agent Engine 14. Each Computer 16 under management of the system of the invention is organized into a logical organization unit Location 18 as defined by a System Administrator 33. Location 18 may or may not be an actual location but rather is a grouping that can be used to organize a plurality of Computers 16 logically based on any criteria desired by System Administrator 33 and is not intended to represent computers in the same geographic location. One or more Locations 18 are further organized into Company 20 which may or may not refer to ownership of the one or more Computers 16 but rather is a grouping that can be used to organize the one or more Computers 16 logically based on any criteria as desired by System Administrator 33. Local Agent Engine 14 can be implemented as a program or utility on each Computer 16 and can enable the functions recited herein.

Local Agent Engine 14 comprises processes that monitor Computer 16 for Privilege Restriction Events 12; determination of Trigger Items 11 by monitoring for dialog boxes, event logs, processes, APIs, or computer configurations; determination and assignment of Trigger Identifiers (TID) 15 which can be used to uniquely identify Trigger Items 11 so that they can be compared to other processes; process rules by either elevating privilege of approved processes or ending processes for rules that are denied; gather information pertaining to Trigger Items 11, other running processes, and computer configuration on Computer 16; communicate information to End User 10 using Computer 16; and communicate information to Cloud Services Engine 50. Rules established by Approver 32 or System Administrator 33 are defined to apply to Computer 16 individually, a collection of one or more Computers 16 in a Location 18, a collection of one or more Locations 18 in Company 20, or a collection of one or more Companies 20 in a Managing Entity 22. The logical organizational units Computer 16, Location 18, Company 20 and Managing Entity 22 are examples of what may be defined by the System Administrator 33 and may include additional collections or groups based on known or unknown criteria and are not exhaustive or intended to be limiting. A Privilege Restriction Event 12 relates to the privilege of User 10, i.e., what actions User 10 is allowed or not allowed to take. User 10 privileges can be managed by the system and method of the invention regardless of the source of the privilege. For example, and without intending to limit the types of privileges that can be managed by the system and method, privileges may relate to the Operating System, an Application, a Website, access to a Device, etc. For example, a Windows Operating System restriction of privilege for system functions and installation of applications is manifested by a Windows UAC Dialog Box which “pops up” and says that elevated credentials are required to take the requested action by User 10. For other actions that may be requested by User 10 (Trigger Items 11), such as the ability to run an application, to access a USB drive that gets attached, or to visit a website, the Privilege Restriction Event will be different for each type of Trigger Item.

Cloud Services Engine 50 may comprise a plurality of common resources that may be housed all on one system or distributed over different systems and networks. Cloud Services Engine 50 handles communication between Local Agent Engine 14, Approver Notification Interface 90, System Administrator Configuration Portal 80, and a plurality of other 3rd party tools or systems 100 that could be used for other management purposes such as remote monitoring, ticketing, remote control, reporting, or other functionality. The examples of potential 3rd party tools or systems are for illustrative example and not exhaustive or intended to be limiting. Cloud Services Engine 50 components comprise an Application Programming Interface (API) 70, Database 72, Data Storage 74, Web Services and Logic 76 and may include but are not limited to computational resources for processing and presenting information as well as various rules and logic, and Artificial Intelligence (“AI”) analytics and computational resources along with stored recommendations provided by 3^{rd} party providers 77.

Each privilege request and event can be referenced by external 3^{rd} Party Tools 100 using unique reference numbers and may also be updated to record the inquiring systems' ticket numbers, record id, incident number, or other information via the system API 70. External systems that track, reference, and update specific Request For Privilege 85 events or other system events recorded on the Cloud Services Engine 50 facilitate the ability for those external systems to incorporate the execution of remote approval or denial decisions, the receipt of notifications, or gathering other system information about, or pertaining to privilege requests and events happening locally on a User 10 using Computer 16. All information displayed in, or any actions that can be carried out directly with the Approver Notification Interface 90 and System Administrator Configuration Portal 80 may also be accessed by or performed from within a 3^{rd} Party Tool 100 connecting via the system API 70.

Communications between Local Agent Engine 14, Cloud Services Engine 50, Approver Notification Interface 90, System Administrator Configuration Portal 80, and 3^{rd} party tools can take place over a plurality of communication interfaces, transport protocols, and media which may include but are not limited to wired ethernet and wireless either publicly or privately on either WAN (wide area networks) or LAN (local area networks), the public Internet, peer to peer technologies, or other communications networks either known or unknown. The examples of potential communications interfaces, methods, transport protocols, and media are for illustrative example and not exhaustive or intended to be limiting. The examples of the components that comprise Cloud Services Engine 50 may comprise additional resources known or unknown and are not exhaustive or intended to be limiting.

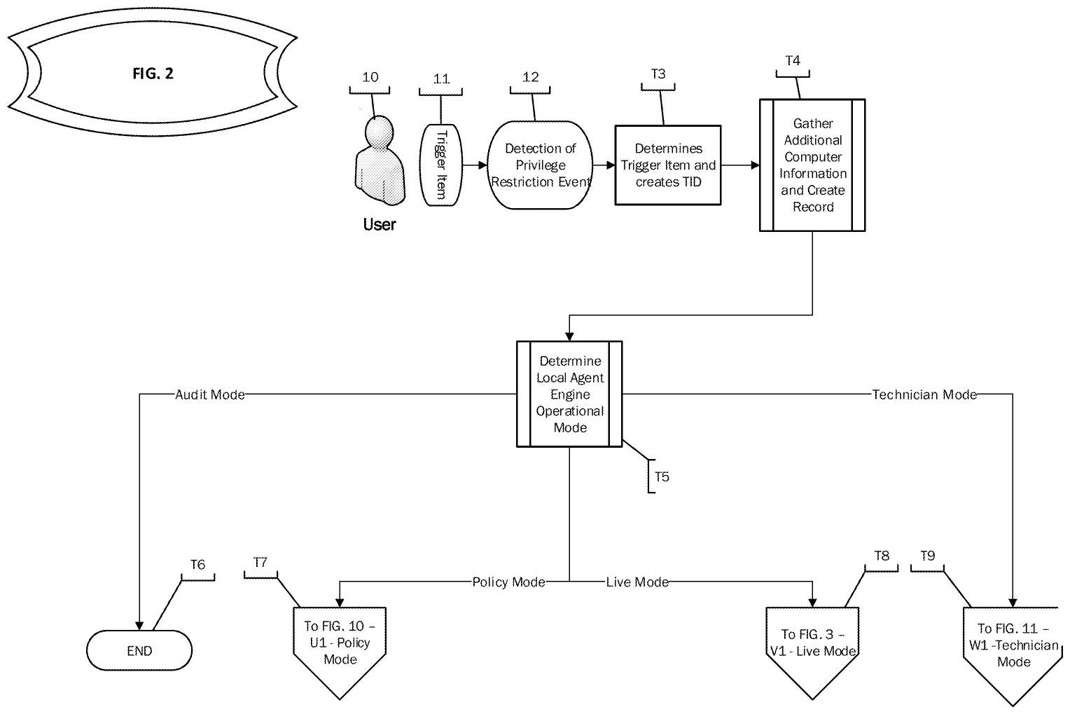

In one embodiment, a master list of approve and deny rules for Trigger Items 11 that have been established by the Approver and System Administrator, if any, are stored in Cloud Services Engine 50. Rules may be defined to apply to a specific Computer 16, a Location 18 with which one or more Computers 16 are associated, a Company 20 with which one or more Locations 18 may be associated, or a Managing Entity 22 which may include one or more Companies 20. In one embodiment, each approve or deny rule is assigned a unique value based on what organizational unit Computer 16, Location 18, Company 20 and Managing Entity 22 the rule is applied to. In one embodiment, Computer 16 is assigned a low numeric value and Managing Entity 22 is assigned a high numeric value. Local Agent Engine 14 applies whatever rule, if any, that matches a trigger access event identity T3 (shown in FIG. 2) that has the lowest numeric value, thus giving priority to rules applied specifically to Computer 16 or, if a matching computer rule does not exist, rules applied specifically to Location 18. Likewise, if a matching location rule does not exist, the rule that is applied is specific to Company 20, and if a matching company rule does not exist, the rule that is applied is specific to Managing Entity 22, and so on. Trigger Items 11 may be comprised of processes, applications, executables, devices, URLs, UNC paths, or “Things” that are currently known or unknown which are restricted by either the Computer Operating System, Application, or another device, and are identified by a Trigger Identifier 15 which may be based off a calculated hash value used for file integrity such as MDS, SHA1, SHA256, and CRC32, or any other criteria such as file name, file path, file size, CLSID, GUID, URL, metadata, publisher, publisher certificate, type of media containing the file, process id, or a combination of any of these criteria. Examples of how Trigger Identifier 15 is calculated are for illustrative example and not exhaustive or intended to be limiting. Each approve or deny rule is associated with a Trigger Identifier 15.

System Administrator Configuration Portal 80 comprises a plurality of typical computational resources that may be all on one system or distributed over different system and networks. System Administrator Configuration Portal 80 communicates with Cloud Services Engine 50 which communicates with Local Agent Engine 14, Approver Notification Interface 90, and 3rd Party Tools 100. System Administrator Configuration Portal 80 is used by System Administrator 33 to configure desired preferences of Local Agent Engine 14, Computer 16, Cloud Services Engine 50, Approver Notification Interface 90, and 3rd Party Tools 100. Additionally, System Administrator Configuration Portal 80 displays information back to System Administrator 33 which may include but is not limited to displaying privilege rules, Privilege Restriction Events 12, information collected from Local Agent Engine 14, lists of Computers 16/Location 18/Company 20, information pertaining to Managing Entity 22, information collected pertaining to any of the components listed above as well as other information that may not be known or listed here. Typical embodiments of Administrator Configuration Portal 80 by way of example may include but are not limited to an app on a mobile device such as an iOS or Android device, a web application or website, a native Windows or MAC application, or an app running on a piece of wearable technology. Typically, Administrator Configuration Portal 80 would be implemented as a program or utility having at least one module but may comprise one or more application programs, other program modules, program data, or some combination thereof necessary to generally carry out the functions and/or methodologies of the invention as described herein.

Approver Notification Interface 90 communicates with Approver 32 in the examination, creation, and Real-Time Evaluation Privilege Process 30 of rules and Request for Privilege 85 or in examining other information contained in the Cloud Services Engine 50. Approver Notification Interface 90 may comprise a plurality of typical computational resources that may be all on one system or distributed over different system and networks. Typical embodiments of Approver Notification Interface 90 by way of example may include but are not limited to an app on a mobile device such as an iOS or Android device, a web application or website, a native Windows or MAC application, or an app running on a piece of wearable technology. Typically, Approver Notification Interface 90 would be implemented as a program or utility having at least one module but may comprise one or more application programs, other program modules, program data, or some combination thereof necessary to generally carry out the functions and/or methodologies of the invention as described herein.

Shown below are illustrative examples of how these teachings may be applied. It is understood that these examples are intended to be illustrative only and are not intended to be limiting:

### Example 1

Administrator Approves a Previously Unknown Application to have Privileges Elevated on a Microsoft Windows® (Microsoft Windows and Related Terms are Trademarks of Microsoft Corporation in the United States and Other Countries) Workstation 1-Time in Real-Time.

End User 10 “User1” who is employed by Company 20 “ABC” is working on Computer 16 which is a Microsoft Windows workstation managed by Managed Computer Support company “MSP-123”. User1 is operating with current user privileges of ‘standard’ which limits execution of applications on Computer 16. User1 attempts to launch Trigger Item 11 comprising an unknown application on Computer 16, a Privilege Restriction Event 12 which causes the Windows operating system to display a UAC dialog box asking for administrator credentials (OS Request For Privilege Dialog Box). The UAC dialog box is immediately dismissed, and User 10 is presented with the option to request elevation of privileges so that Trigger Item 11 can be executed on Computer 16. If User 10 chooses to proceed then Computer 10 sends computer and process information including information regarding Trigger Item 11 to Cloud Services Engine 50 via API 70 thus creating Request For Privilege 85 and thereafter initiating the Real-Time Privilege Evaluation Process 30. Request for Privilege 85 is sent to Approver 32 at MSP-123 who evaluates the risks to either approve or deny the launch process of Trigger Item 11 to continue. Approver 32 decides to approve the Request for Privilege 85 for this single instance. Approval is communicated back to User 1 and Trigger Item 11 is re-launched with privileges elevated to ‘Administrator’ so that execution of Trigger Item 11 can continue on Computer 16.

### Example 2

Administrator Approves a Previously Unknown Application to have Privileges Elevated on a Microsoft Windows Workstation and Makes a Rule to Define the Application as ‘Approved’ for Future Requests in Real-Time.

End User 10 “User1” who is employed by Company 20 “ABC” is working on Computer 16 which is a Microsoft Windows workstation managed by Managed Computer Support company “MSP-123”. User1 is operating with current user privileges of ‘standard’ which limits execution of applications on Computer 16. User1 attempts to launch Trigger Item 11 comprising an unknown application on Computer 16, a Privilege Restriction Event 12 which causes the Windows operating system to display a UAC dialog box asking for administrator credentials (OS Request For Privilege Dialog Box. The UAC dialog box is immediately dismissed, and User 10 is presented with option to request elevation of privileges so that Trigger Item 11 can be executed on Computer 16. If User 10 chooses to proceed then Computer 10 sends computer and process information including information regarding Trigger Item 11 to Cloud Services Engine 50 via API 70 thus creating Request For Privilege 85 and thereafter initiating the Real-Time Privilege Evaluation Process 30. Request for Privilege 85 is sent to Approver 32 at MSP-123 who evaluates the risks to either approve or deny the launch process of Trigger Item 11 to continue. Approver 32 decides to approve the elevation and make a rule for future requests by Computers 16 that also are managed by MSP-123 for Company 20 “ABC.” The approval is communicated back to Computer 16 and Trigger Item 11 is re-launched with privileges elevated to ‘Administrator’ so that execution of Trigger Item 11 can continue on Computer 16 operated by User1. Thereafter, another End User 10 “User2” attempts execution of Trigger Item 11 on a different Computer 16 as did User1, where User1 and User2 are operating Computers 16 that are both managed by MSP-123 for Company 20 “ABC.” This is a Privilege Restriction Event 12 which causes the Windows operating system of Computer 16 operated by User2 to display a UAC dialog box asking for administrator credentials. The UAC dialog box (OS Request For Privilege Dialog Box) is detected and Trigger Item 11 is identified. The UAC dialog box is dismissed. Trigger Item 11 is recognized as approved at Cloud Services Engine 50 because of the rule that was established during the Real-Time Privilege Evaluation Process 30 for User1 and Trigger Item 11 is then re-launched with privileges automatically elevated to ‘Administrator’ privileges so the execution of Trigger Item 11 can continue on Computer 16 operated by User2.

### Example 3

Administrator Denies a Previously Unknown Application which is being Requested by User1 from being Launched in Real-Time.

End User 10 “User1” who is employed by Company 20 “ABC” is working on Computer 16 which is a Microsoft Windows workstation managed by Managed Computer Support company “MSP-123”. User1 is operating with current user privileges of ‘standard’ which limits execution of applications on Computer 16. User1 attempts to launch Trigger Item 11 comprising an unknown application on Computer 16, a Privilege Restriction Event 12 which causes the Windows operating system to display a UAC dialog box asking for administrator credentials (OS Request For Privilege Dialog Box). The UAC dialog box is immediately dismissed and User 10 is presented with option to request elevation of privileges so that Trigger Item 11 can be executed on Computer 16. If User 10 chooses to proceed then Computer 10 sends computer and process information including information regarding Trigger Item 11 to Cloud Services Engine 50 via API 70 thus creating Request For Privilege 85 and thereafter initiating the Real-Time Privilege Evaluation Process 30. Request for Privilege 85 is sent to Approver 32 at MSP-123 who evaluates the risks to either approve or deny the launch process of Trigger Item 11 to continue. Approver 32 decides to deny the elevation for this specific instance. The denial is communicated back to Computer 16 operated by User1 and the execution process of Trigger Item 11 is terminated on Computer 16.

### Example 4

Administrator Denies a Previously Unknown Application which is being Requested by User1 and Makes a Rule to Define the Application as ‘Denied’ for Future Requests in Real-Time.

End User 10 “User1” who is employed by Company 20 “ABC” is working on Computer 16 which is a Microsoft Windows workstation managed by Managed Computer Support company “MSP-123”. User1 is operating with current user privileges of ‘standard’ which limits execution of applications on Computer 16. User1 attempts to launch Trigger Item 11 comprising an unknown application on Computer 16, a Privilege Restriction Event 12 which causes the Windows operating system to display a UAC dialog box asking for administrator credentials (OS Request For Privilege Dialog Box). The UAC dialog box is immediately dismissed and User 10 is presented with option to request elevation of privileges so that Trigger Item 11 can be executed on Computer 16. If User 10 chooses to proceed then Computer 10 sends computer and process information including information regarding Trigger Item 11 to Cloud Services Engine 50 via API 70 thus creating Request For Privilege 85 and thereafter initiating the Real-Time Privilege Evaluation Process 30. Request for Privilege 85 is sent to Approver 32 at MSP-123 who evaluates the risks to either approve or deny the launch process of Trigger Item 11 to continue. Approver 32 decides to deny the elevation for this instance and to make a rule for future requests by Computers 16 that also are managed by MSP-123 for Company 20 “ABC.” The denial is communicated back to Computer 16 operated by User1 and the execution of Trigger Item 11 is terminated on Computer 16. Thereafter, another End User 10 “User2” attempts execution of Trigger Item 11 on a different Computer 16 as did User1, where User1 and User2 are operating Computers 16 that are both managed by MSP-123 for Company 20 “ABC.”. This is a Privilege Restriction Event 12 which causes the Windows operating system of Computer 16 operated by User2 to display a UAC dialog box asking for administrator credentials. The UAC dialog box (OS Request For Privilege Dialog Box) is detected and Trigger Item 11 is identified. This time, Trigger Item 11 is recognized as denied at Cloud Services Engine 50 because of the rule that was established during the Real-Time Privilege Evaluation Process 30 for User1 and the execution of Trigger Item 11 on Computer 16 operated by User2 is automatically terminated.

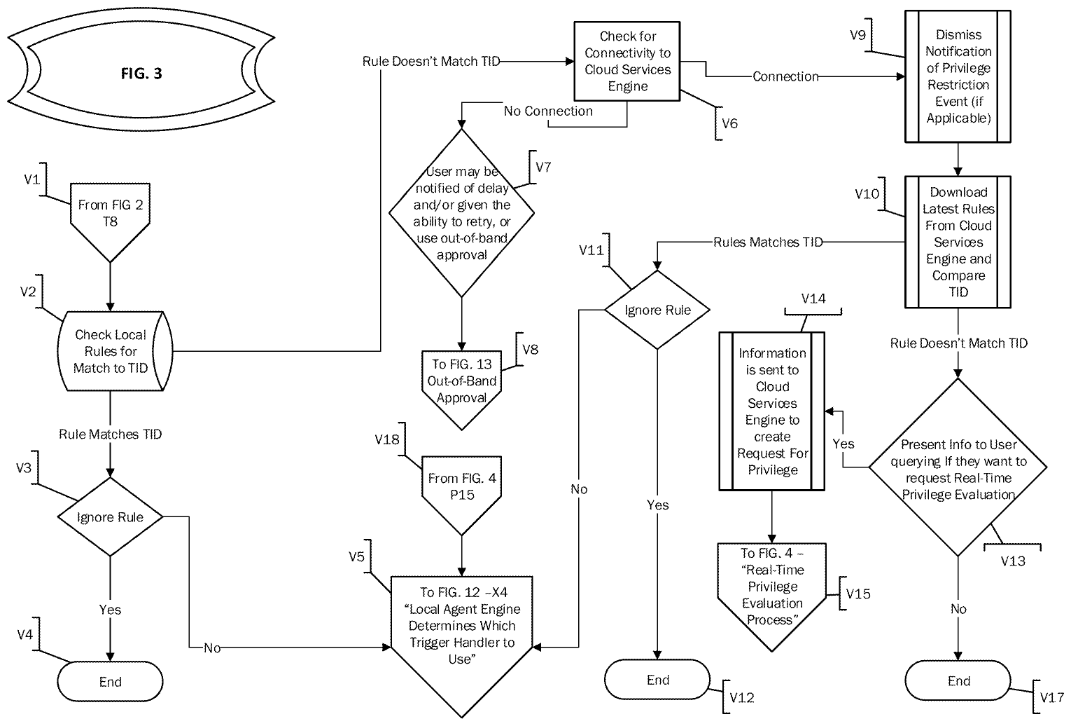

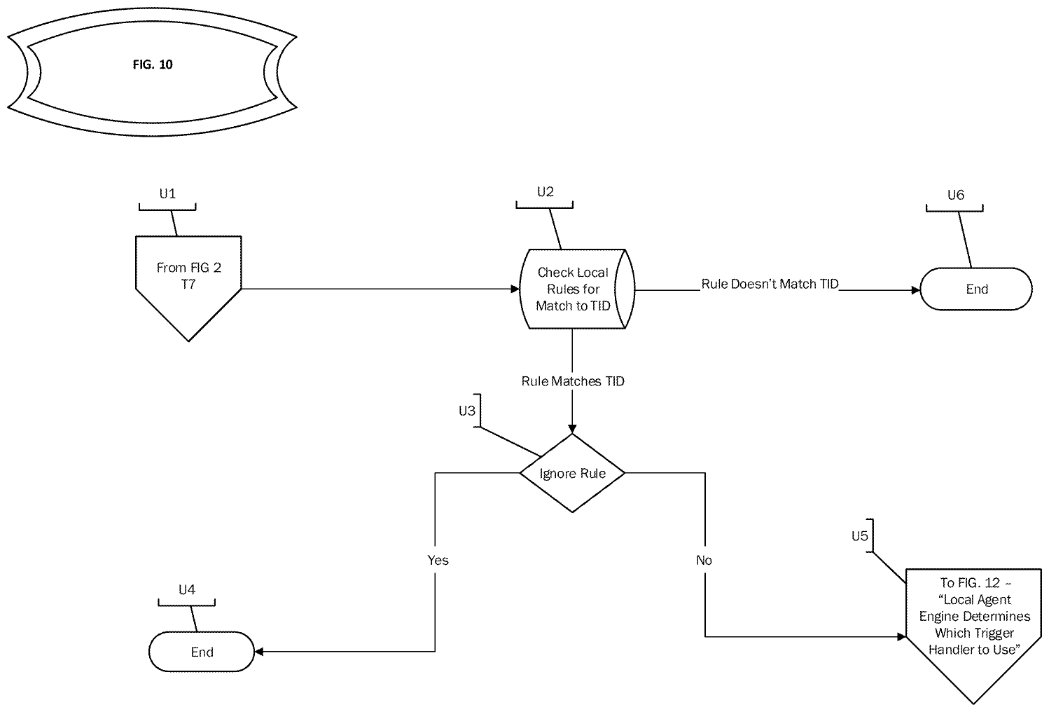

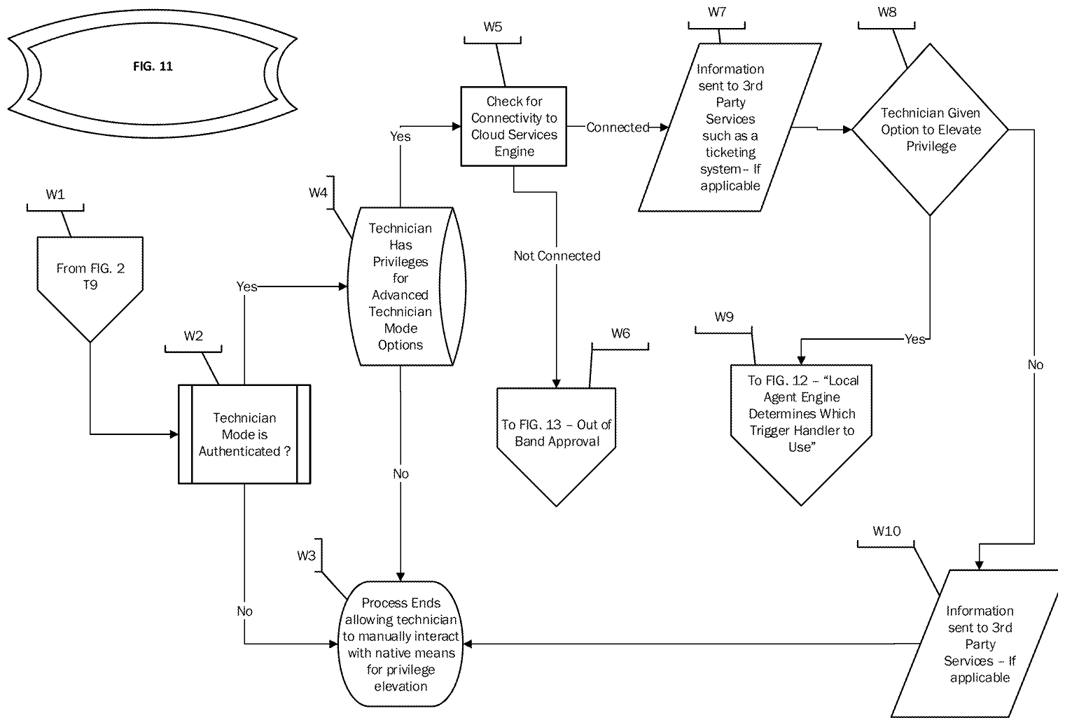

FIG. 2 depicts an illustrative flow diagram for the initial steps of the Request for Privilege Evaluation 85 process according to one embodiment of the invention. End User 10 interacts with Computer 16 which contains a Local Agent Engine 14 (FIG. 1-14). In this embodiment, Local Agent Engine 14 (FIG. 1-14) detects a Privilege Restriction Event 12 generated by Computer 16. Local Agent Engine 14 (FIG. 1-14) determines the Trigger Item 11 (FIG. 1-11) identity for Privilege Restriction Event 12 at T3 and generates a Trigger Identifier (TID) 15. Additional information is gathered at T4 about the computer system, users, and applications which may become useful to Approver 32 (FIG. 1-32) in determining whether to either approve or deny a Request For Privilege 85 (FIG. 1-85). The information gathered may include but is not limited to: a record of all running processes on the computer, Trigger Identifier (TID), Trigger Item 11 file path and name, Trigger Item 11 publisher's certificate information, Trigger Item 11 file metadata/file name/file path/file size, computer system state information of Computer 16 such as: if system restore is on or off, file or OS backup status, if system antivirus software is installed and/or enabled, logged in user, user privilege, users membership in privilege groups, information supplied by the user, information regarding other user accounts on the computer, information regarding the presence of any attached storage devices or connected network storage, information associated with or supplied by 3^{rd} party services or tools, and network connection status and configuration. The preceding list is for example purposes and is not meant to being limiting. Local Agent Engine (FIG. 1-14) determines the operational mode that the System Administrator 33 (FIG. 1-33) or Approver 32 (FIG. 1-32) has previously selected as their preference for the Computer 16. The operational mode that is active (i.e., whether the agent is in Audit, Policy, Live or Technician Mode) on the Local Agent Engine at T5 then dictates how rules are processed. If operational mode is found to be Audit Mode, Local Agent Engine (FIG. 1-14) ends the process at T6. If operational mode is found to be Policy Mode, then actions are processed according to the Policy Mode routine (FIG. 10) at T7. If operational mode is found to be Live Mode, then actions are processed according to the Live Mode routine (FIG. 3) at T8. If operational mode is found to be Technician Mode, then actions are processed according to the Technician Mode routine (FIG. 11) at T9.

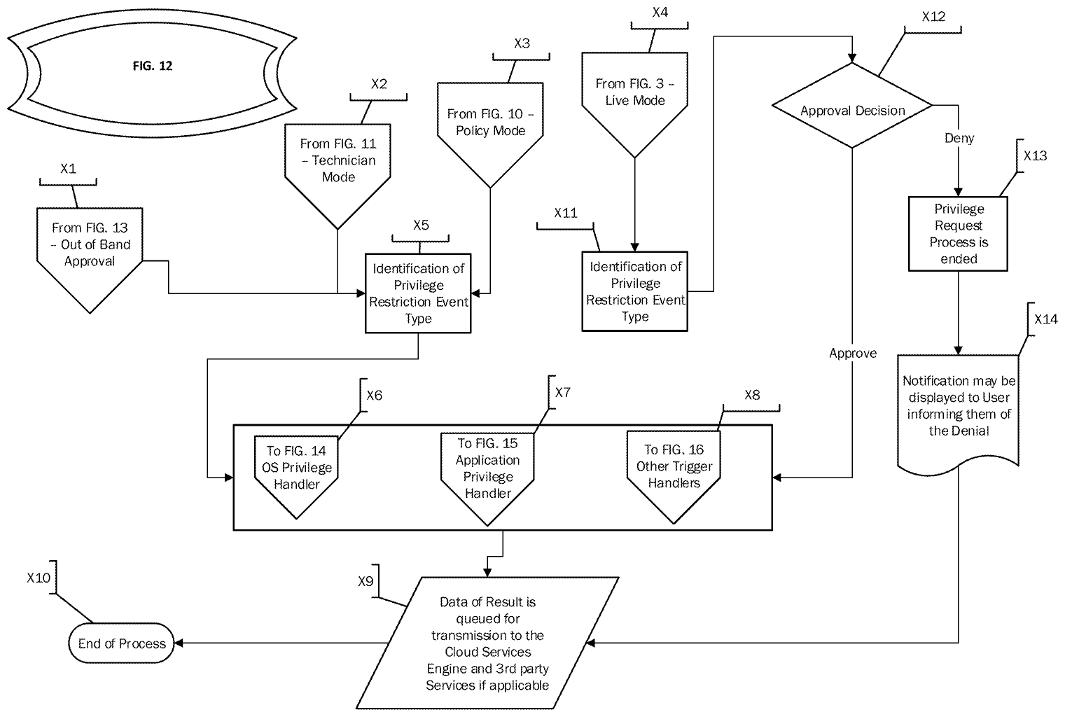

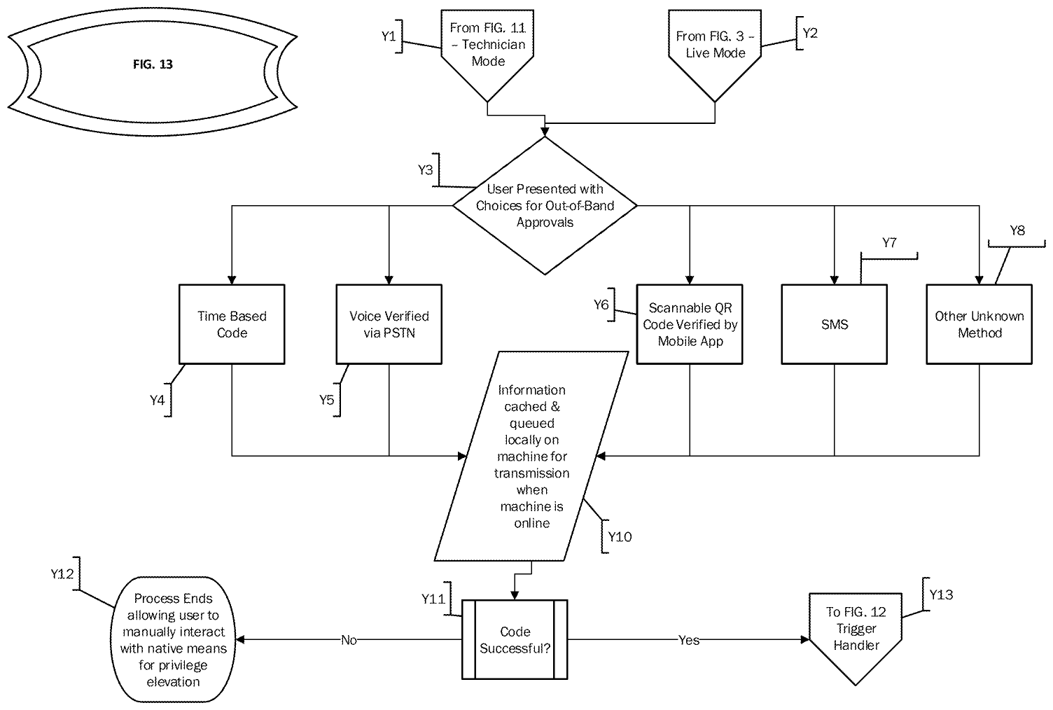

FIG. 3 depicts an illustrative flow diagram of a sub-process on Local Agent Engine 14 (FIG. 1-14) when the Trigger Handler Routing (FIG. 12) is set to Live Mode (FIG. 2) at T8. In this embodiment, Local Agent Engine 14 (FIG. 1-14) generates TID 15 at T3 (FIG. 2-T3) and checks locally stored rules at V2 for a matching TID 15 (FIG. 1-15). If a rule is located at V2 that matches TID 15 (FIG. 1-15), at V3 Local Agent Engine 14 (FIG. 1-14) determines if the matching rule is set to ignore or not ignore. If the matching rule is set to not ignore, then Local Agent Engine 14 (FIG. 1-14) determines which Trigger Handler to use (FIG. 12-X4) at V5. If the matching rule is set to ignore, then Local Agent Engine 14 (FIG. 1-14) carries out no further action and the evaluation process is ended at V4. If there is no matching rule located at V2 that matches TID 15 (FIG. 1-15), then Local Agent Engine 14 (FIG. 1-14) checks for connectivity to Cloud Services Engine 50 (FIG. 1-50) at V6. If Local Agent Engine 50 (FIG. 1-50) is unable to contact Cloud Services Engine 50 (FIG. 1-50) End User 10 may be given the option of attempting the connection again or using out-of-band approval (See FIG. 13) at V8.

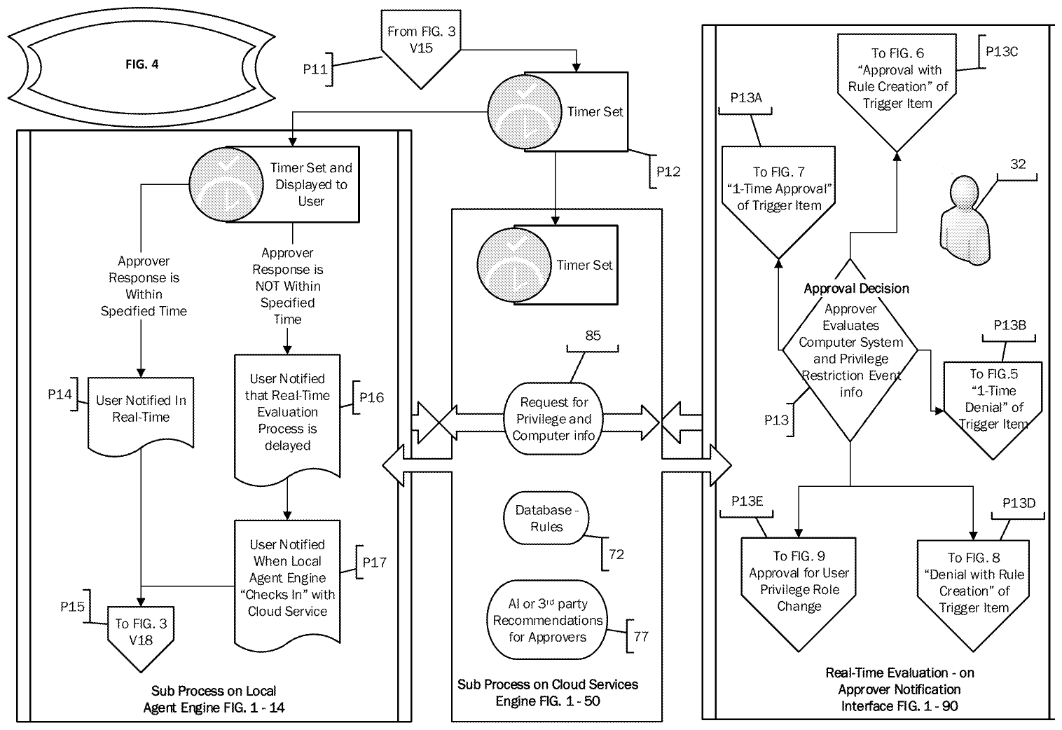

If Cloud Services Engine 50 (FIG. 1-50) can be reached, any notification produced as a result of the Privilege Restriction Event 12 (FIG. 1-12) initiated by the Trigger Item 11 (FIG. 1-11) may be dismissed at V9. Local Agent Engine 14 (FIG. 1-14) is initiated to download a current copy of the approve and deny rules from Cloud Services Engine 50 (FIG. 1-50) via API 70 (FIG. 1-70) at V10. Local Agent Engine 14 (FIG. 1-14) compares the Trigger Identifier 15 (FIG. 1-15) to the freshly downloaded list of approve/deny rules. If a matching rule is found on the Local Agent Engine 14 (FIG. 1-14) from the freshly downloaded list of rules at V10 that matches TID 15 (FIG. 1-15), at V11 Local Agent Engine 14 (FIG. 1-14) determines if the matching rule is set to ignore or not ignore. If the matching rule is set to not ignore, then Local Agent Engine 14 (FIG. 1-14) determines which Trigger Handler to use (FIG. 12-X3) at V5. If the matching rule is set to ignore, then Local Agent Engine 14 (FIG. 1-14) carries out no further action and the evaluation process is ended at V12. If there is no matching rule for the Trigger Identifier 15 (FIG. 1-15) that is associated with Trigger Item 11 (FIG. 1-11) which initiated the chain of events for Privilege Restriction Event 12 (FIG. 1-12), information is presented to End User 10 (FIG. 1-10) querying if End User 10 (FIG. 1-10) would like to initiate Real-Time Privilege Evaluation Process 30 (FIG. 1-30) for Privilege Restriction Event 12 (FIG. 1-12) at V13. If End User 10 (FIG. 1-10) selects ‘No’ the evaluation process is ended and execution of Trigger Item 11 (FIG. 1-11) ends at V17. If End User 10 (FIG. 1-10) selects ‘yes’ Cloud Services Engine 50 (FIG. 1-50) assembles the Request For Privilege 85 (FIG. 1-85) along with computer and process information of Computer 16 (FIG. 1-16) at V14, and the Real-Time Privilege Evaluation Process 30 (FIG. 1-30) is initiated at V15 (see FIG. 4).

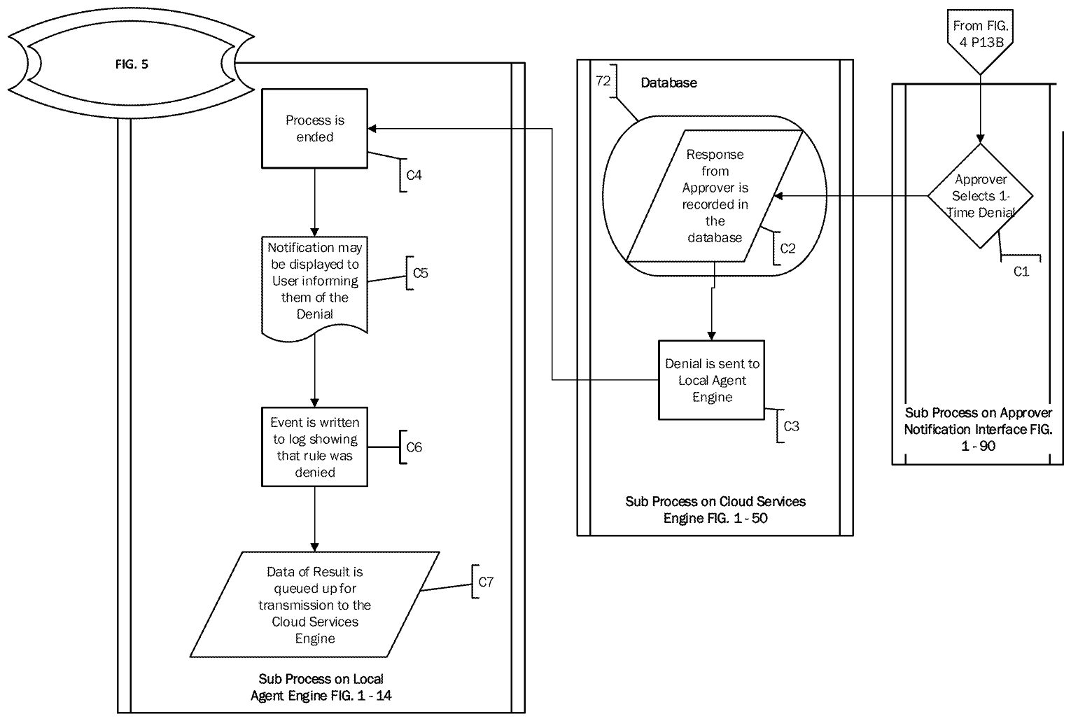

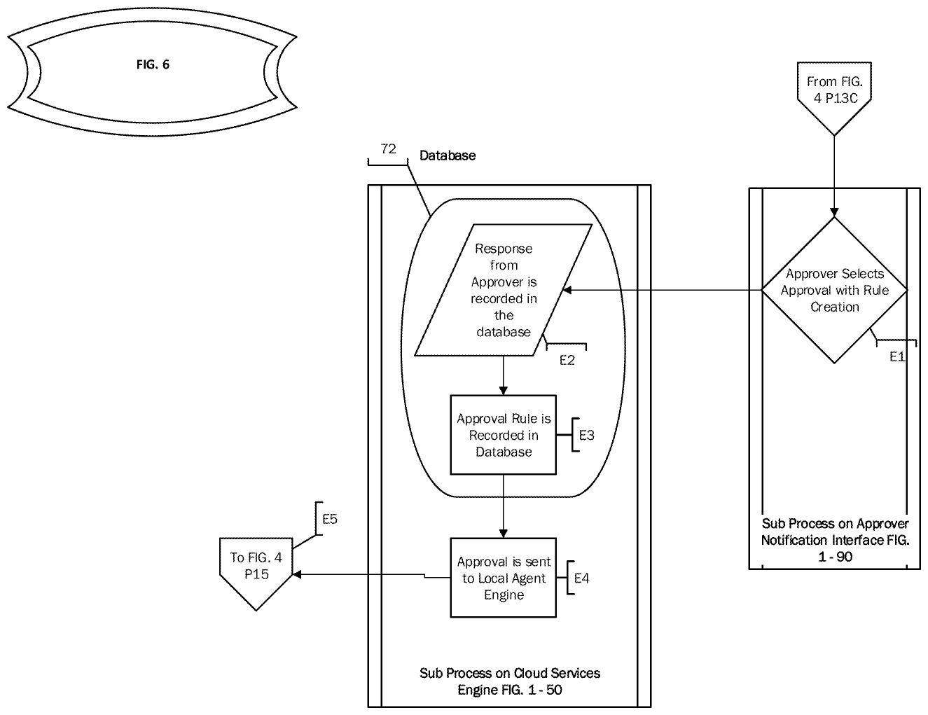

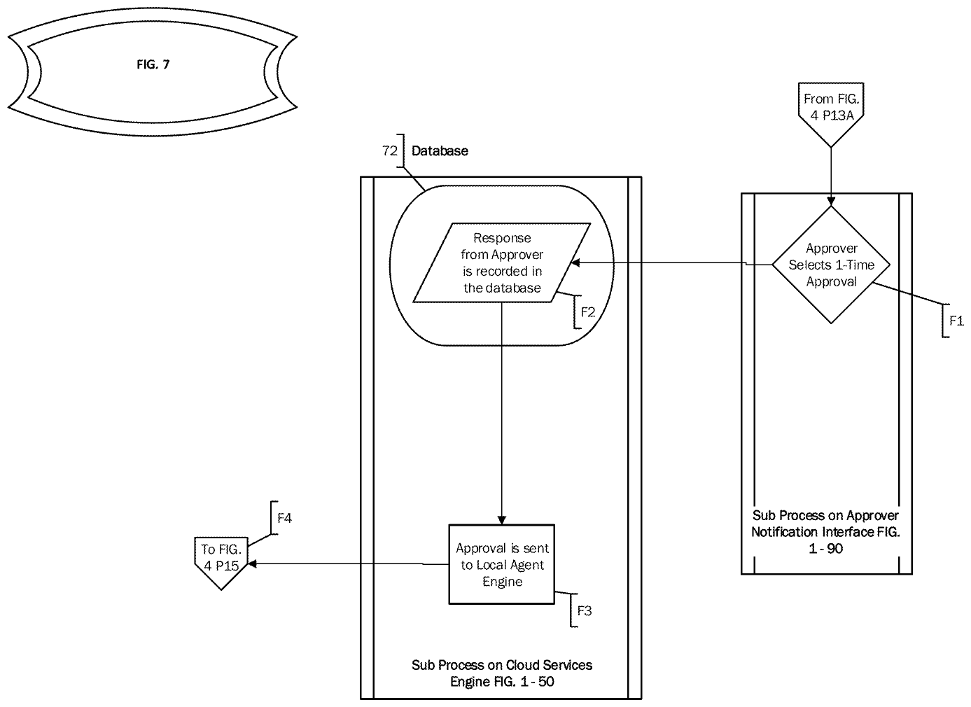

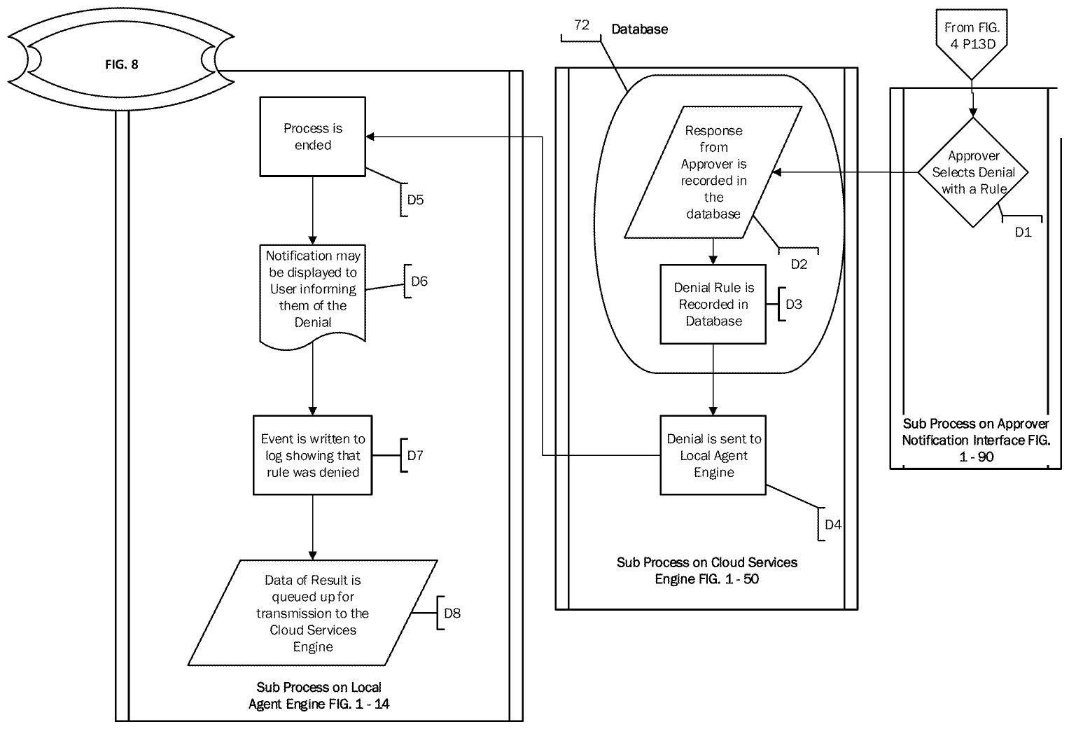

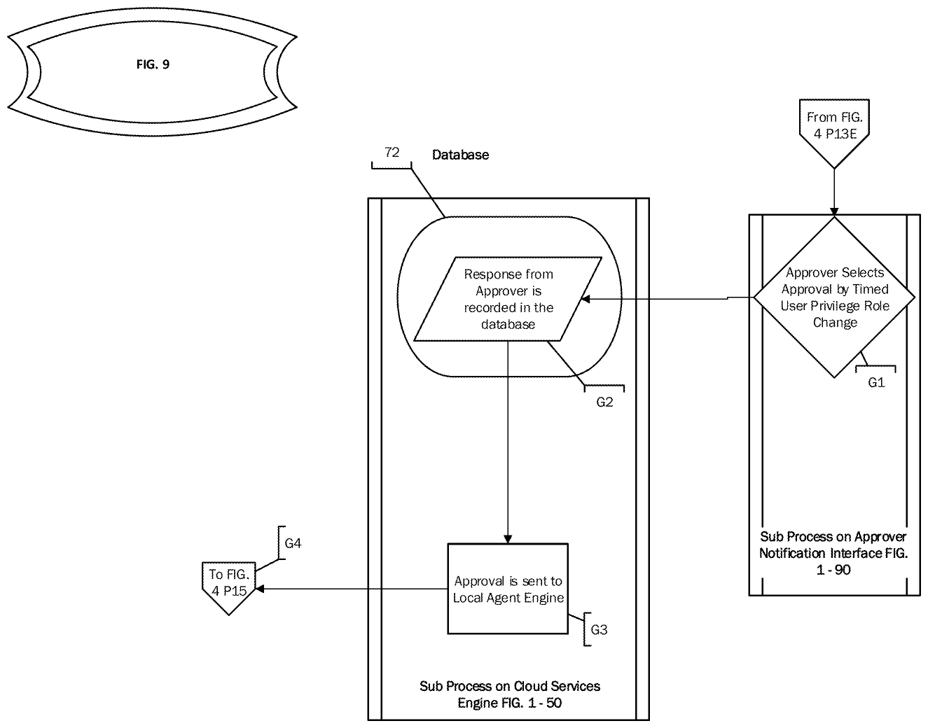

FIG. 4 depicts an illustrative flow diagram of the Real-Time Privilege Evaluation process. When Real-Time Privilege Evaluation is initiated at P11 (See FIG. 3-V15) a timer is started at P12 on Local Agent Engine 14 (FIG. 1-14) and on Cloud Services Engine 50 (FIG. 1-50). Depending on preferences of Approver 32 (FIG. 1-32), a dialog box may be presented to End User 10 (FIG. 1-10) which displays progress, timing, and information pertaining to the process and status of the Request For Privilege 85 made to initiate the Real-Time Privilege Evaluation Process. The Request For Privilege 85 (FIG. 1-85) is transmitted by Local Agent Engine 14 (FIG. 1-14) to Cloud Services Engine 50 (FIG. 1-50). Cloud Services Engine 50 (FIG. 1-50) sends the Request For Privilege 85 (FIG. 1-85) along with computer configuration and processes of Computer 16 (FIG. 1-16) to Approver Notification Interface 90 (FIG. 1-90) for evaluation of the Request For Privilege 85 (FIG. 1-85) by Approver 32 (FIG. 1-32). Approver 32 (FIG. 1-32) has a specified amount of time to respond with an Approval Decision of either 1-Time approval/denial or approval/denial with creation of an associated rule at P13. Approver 32 (FIG. 1-32) may respond with one of the following 5 choices:
If 1-Time Approval for a Trigger Item (see FIG. 7) is selected by the Approver 32 (FIG. 1-32) at P13A, the approval is transmitted to the Cloud Services Engine 50 (FIG. 1-50) from the Approver Notification Interface 90 (FIG. 1-90) which marks the TID 15 (FIG. 1-15) for Trigger Item 11 (FIG. 1-11) as approved for this instance only. Local Agent Engine 14 (FIG. 1-14) is notified of the 1-Time Approval by Cloud Services Engine 50 (FIG. 1-50). Notification of the approval is displayed on Computer 16 (FIG. 1-16) to End User 10 (FIG. 1-10) at P14, allowing Computer 16 (FIG. 1-16) to relaunch the approved Trigger Item 11 (FIG. 1-11) with elevated Administrator privileges at P15.
If Approval with a Rule for a Trigger Item (see FIG. 6) is selected by the Approver 32 (FIG. 1-32) at P13C, approval is transmitted to the Cloud Services Engine 50 (FIG. 1-50) from the Approver Notification Interface 90 (FIG. 1-90) which marks TID 15 (FIG. 1-15) for Trigger Item 11 (FIG. 1-11) as approved and creates an approval rule which is stored in Database 72 (FIG. 1-72). Local Agent Engine 14 (FIG. 1-14) is notified of the approval by Cloud Services Engine 50 (FIG. 1-50). Notification of the approval is displayed on Computer 16 (FIG. 1-16) to End User 10 (FIG. 1-10) at P14, allowing Computer 16 (FIG. 1-16) to relaunch approved Trigger Item 11 (FIG. 1-11) with elevated Administrator privileges at P15.
If 1-Time Denial for a Trigger Item (see FIG. 5) is selected by Approver 32 (FIG. 1-32) at P13B, the denial is transmitted to the Cloud Services Engine 50 (FIG. 1-50) from the Approver Notification Interface 90 (FIG. 1-90) which marks TID 15 (FIG. 1-15) for Trigger Item 11 (FIG. 1-11) as denied for this instance only. Local Agent Engine 14 (FIG. 1-14) is notified of the 1-Time Denial by Cloud Services Engine 50 (FIG. 1-50). Notification of the denial is displayed on Computer 16 (FIG. 1-16) to End User 10 (FIG. 1-10) at P14, and the execution process of Trigger Item 11 (FIG. 1-11) is ended at P15.
If Denial with a Rule for a Trigger Item (see FIG. 8) is selected by Approver 32 (FIG. 1-32) at P13D, denial is transmitted to the Cloud Services Engine 50 (FIG. 1-50) from the Approver Notification Interface 90 (FIG. 1-90) which marks TID 15 (FIG. 1-15) for Trigger Item 11 (FIG. 1-11) as denied and creates a denial rule which is stored in Database 72 (FIG. 1-72). Local Agent Engine 14 (FIG. 1-14) is notified of the denial by Cloud Services Engine 50 (FIG. 1-50). Notification of the denial is displayed on Computer 16 (FIG. 1-16) to End User 10 (FIG. 1-10) at P14, and the execution of Trigger Item 11 (FIG. 1-11) is ended at P15.
If Approval For User Privilege Role (see FIG. 9) is selected by the Approver 32 (FIG. 1-32) at P13E, approval is transmitted to the Cloud Services Engine 50 (FIG. 1-50) from the Approver Notification Interface 90 (FIG. 1-90) which stores response and status in Database 72 (FIG. 1-72). Local Agent Engine 14 (FIG. 1-14) is notified of the approval or when applicable may also be sent to an application, service, or 3^{rd} Party Tools 100 (FIG. 1-100) either locally or via API 70 (FIG. 1-70) by Cloud Services Engine 50 (FIG. 1-50). Notification of the approval is displayed on Computer 16 (FIG. 1-16) to End User 10 (FIG. 1-10) at P14, allowing End User's (FIG. 1-10) user privilege role for the Trigger Handler type to be elevated to Administrator privileges at P15.

If Approver 32 (FIG. 1-32) does not respond with the specified amount of time indicated by the timer displayed to End User 10 (FIG. 1-10) at P12, Local Agent Engine 14 (FIG. 1-14) displays a notification to End User 10 (FIG. 1-10) with additional information pertaining to the reason for the delay at P16. When Approver 32 (FIG. 1-32) responds, Cloud Services Engine 50 (FIG. 1-50) is updated with the result and the information is updated to Local Agent Engine 14 (FIG. 1-14) at P17. Local Agent Engine 14 (FIG. 1-14) initiates further processing of the TID 15 (FIG. 1-15) in Live Mode (FIG. 3-V18) by determining which Trigger Handler to use (FIG. 12-X4). A Trigger Handler is a routine that the Local Agent Engine 14 (FIG. 1-14) follows to elevate privileges for a particular Privilege Restriction Event 12 (FIG. 1-12). For example and without intending to limit the invention, the routine for a Windows OS Privilege Escalation Event (aka Windows UAC) is one type of Trigger Handler whereas the Trigger Handler for elevating privilege to allow access to an attached device, access an application, or access a website will be different. Trigger Handlers may be developed for use with the system and method for potentially anything where privilege is restricted.

FIG. 5 depicts an illustrative flow diagram of the Real-Time Privilege Evaluation Process (FIG. 4) when Approver 32 (FIG. 1-32) chooses the option for 1-Time Denial for a Trigger Item (FIG. 4-P13B) at C1. Response from Approver 32 (FIG. 1-32) is recorded in Database 72 (FIG. 1-72) at C2 and denial is transmitted by Cloud Services Engine 50 (FIG. 1-50) to Local Agent Engine 14 (FIG. 1-14) at C3. Local Agent Engine 14 (FIG. 1-14) ends the elevation process at C4. Notification may be sent to End User 10 (FIG. 1-10) at C5, an event is written to a log of Computer 16 (FIG. 1-16) showing that the rule was denied at C6, and the result of how the denial rule was processed is queued up for transmission by Local Agent Engine 14 (FIG. 1-14) to Cloud Services Engine 50 (FIG. 1-50) at C7.

FIG. 6 depicts an illustrative flow diagram of the Real-Time Privilege Evaluation Process (FIG. 4) when the Approver 32 (FIG. 1-32) chooses the option for Approval with Rule for a Trigger Item (FIG. 4-P13C) at E1. Response from Approver 32 (FIG. 1-32) is recorded in Database 72 (FIG. 1-72) at E2 and the approval rule is recorded in Database (FIG. 1-72) at E3. Approval is then transmitted by Cloud Services Engine 50 (FIG. 1-50) to Local Agent Engine 14 (FIG. 1-14) at E5 for processing (See FIG. 4-P15).

FIG. 7 depicts an illustrative flow diagram of the Real-Time Privilege Evaluation Process (FIG. 4) when the Approver 32 (FIG. 1-32) chooses the option for 1-Time Approval for a Trigger Item (FIG. 4-P13A) at F1. Response from Approver 32 (FIG. 1-32) is recorded in Database 72 (FIG. 1-72) at F2 and approval is transmitted by Cloud Services Engine (FIG. 1-50) to Local Agent Engine 14 (FIG. 1-14) at F3 for processing by Local Agent Engine 14 (FIG. 1-14) at F4 for processing (see FIG. 4-P15).

FIG. 8 depicts an illustrative flow diagram of the Real-Time Privilege Evaluation Process (FIG. 4) when Approver 32 (FIG. 1-32) chooses the option for Denial with Rule for a Trigger Item (see FIG. 4-P13D) at D1. Response from Approver 32 (FIG. 1-32) is recorded in Database 72 (FIG. 1-72) at D2 and the denial rule is recorded in Database (FIG. 1-72) at D3. Denial is then transmitted by Cloud Services Engine 50 (FIG. 1-50) to Local Agent Engine 14 (FIG. 1-14) at D4 for processing. Local Agent Engine 14 (FIG. 1-14) ends the elevation process at D5, notification may be sent to End User 10 (FIG. 1-10) at D6, the denial event is written to a log on Computer 16 (FIG. 1-16) showing that the rule was denied at D7. The result of how the denial rule was processed is queued up for transmission by Local Agent Engine 14 (FIG. 1-14) to Cloud Services Engine 50 (FIG. 1-50) at D8.

FIG. 9 depicts an illustrative flow diagram of the Real-Time Privilege Evaluation Process (FIG. 4) when the Approver 32 (FIG. 1-32) chooses the option for Approval with User Privilege Role (FIG. 4-P13E) at G1. Response from Approver 32 (FIG. 1-32) and status of authorization to elevate User Privilege Role being granted is recorded in Database 72 (FIG. 1-72) at G2. Approval is then transmitted by Cloud Services Engine 50 (FIG. 1-50) and then to Local Agent Engine 14 (FIG. 1-14) or when applicable may also be sent to an application, service, or 3^{rd} Party Tools 100 (FIG. 1-100) either locally or via API 70 (FIG. 1-70) at G3 for processing (See FIG. 4-P15).

FIG. 10 depicts an illustrative flow diagram of a sub-process on Local Agent Engine 14 (FIG. 1-14) when Trigger Handler Routing (FIG. 12) is set to Policy Mode (FIG. 2) at T7. In this embodiment, Local Agent Engine 14 (FIG. 1-14) generates TID 15 (FIG. 1-15) at T3 (FIG. 2-T3) and checks locally stored rules at U2 for a matching TID 15 (FIG. 1-15). If a rule is located at U2 that matches TID 15 (FIG. 1-15), at U3 Local Agent Engine 14 (FIG. 1-14) determines if the matching rule is set to ignore or not ignore. If the matching rule is set to not ignore, then Local Agent Engine 14 (FIG. 1-14) determines which Trigger Handler to use (FIG. 12-X3) at U5. If the matching rule is set to ignore, then Local Agent Engine 14 (FIG. 1-14) carries out no further action and the evaluation process is ended at U4. If there is no matching rule located at U2 that matches TID 15 (FIG. 1-15), then Local Agent Engine 14 (FIG. 1-14) carries out no further action and the evaluation process is ended at U6.

FIG. 11 depicts an illustrative flow diagram of a sub-process on Local Agent Engine 14 (FIG. 1-14) when the Trigger Handler Routing (FIG. 12) is set to Technician Mode (FIG. 2) at T9. In this embodiment, Local Agent Engine 14 (FIG. 1-14) determines if Approver 32 (FIG. 1-32) has successfully authenticated locally on Computer 16 (FIG. 1-16) at W2. Authentication may be accomplished by the Local Agent Engine 14 (FIG. 1-14) using a variety of commercially available technologies currently known or unknown to verify and ensure the identity of the Approver 32. If Approver 32 (FIG. 1-32) is not authenticated, then evaluation process ends at W3. If Approver 32 (FIG. 1-32) has successfully authenticated, Local Agent Engine 14 (FIG. 1-14) determines if authenticated Approver 32 (FIG. 1-32) has privileges for Advanced Technician Mode Options enabled at W4. If Advanced Technician Mode Options are not enabled the evaluation process ends at W3. If Advanced Technician Mode Options are enabled Local Agent Engine 14 (FIG. 1-14) checks for connectivity to Cloud Services Engine 50 (FIG. 1-50) at W5. If Local Agent Engine 14 (FIG. 1-14) is unable to contact Cloud Services Engine 50 (FIG. 1-50) End User 10 (FIG. 1-10) may be given the option of attempting the connection again or using out-of-band approval (See FIG. 13) at W6. If Cloud Services Engine 50 (FIG. 1-50) can be reached, information may be sent to 3^{rd} Party Tools or Services 100 (FIG. 1-100) via API 70 (FIG. 1-70) at W7. Authenticated Approver 32 (FIG. 1-32) is queried with option to elevate privilege at W8. If authenticated Approver 32 (FIG. 1-32) would like to elevate privilege, then Local Agent Engine 14 (FIG. 1-14) determines which Trigger Handler to use (FIG. 12-X2) at W9. If Authenticated Approver 32 (FIG. 1-32) does not want to elevate privilege, information may be sent to 3^{rd} Party Tools or Services (FIG. 1-100) via API 70 (FIG. 1-70) at W10 and the evaluation process ends at W3.

FIG. 12 depicts an illustrative flow diagram of a sub-process on Local Agent Engine 14 (FIG. 1-14) of Trigger Handler Routing. In this embodiment, Local Agent Engine 14 (FIG. 1-14) has determined that the TID 15 (FIG. 1-15) is approved for elevation and that the Local Agent Engine 14 (FIG. 1-14) has an active operational mode previously set by the System Administrator 33 (FIG. 1-33) or Approver 32 (FIG. 1-32) for the Computer 16 (FIG. 1-16) of Technician Mode (FIG. 11) at X2, Policy Mode (FIG. 10) at X3, or has been approved offline using Out of Band Approval (FIG. 13) at X1. Local Agent Engine (FIG. 1-14) determines the type of elevation required by the TID 15 (FIG. 1-15) at X5 and then processes the request according to the appropriate privilege handler. The result of how the rule was processed is queued up for transmission by Local Agent Engine 14 (FIG. 1-14) to Cloud Services Engine 50 (FIG. 1-50) at X9, information may be sent to 3^{rd} Party Tools or Services (FIG. 1-100) via API 70 (FIG. 1-70) at X9 and the evaluation process ends at X10.

In another embodiment, Local Agent Engine 14 (FIG. 1-14) has determined that the TID 15 (FIG. 1-15) is approved for elevation and that the Local Agent Engine 14 (FIG. 1-14) has an active operational mode previously set by the System Administrator 33 (FIG. 1-33) or Approver 32 (FIG. 1-32) for the Computer 16 (FIG. 1-16) of Live Mode (FIG. 3) at X4. Local Agent Engine (FIG. 1-14) determines the type of elevation required by the TID 15 (FIG. 1-15) at X11. When an Approval Decision (FIG. 4-P13) is received at X12, if it is approved then the Local Agent Engine (FIG. 1-14) processes the request according to the appropriate privilege handler. The result of how the rule was processed is queued up for transmission by Local Agent Engine 14 (FIG. 1-14) to Cloud Services Engine 50 (FIG. 1-50) at X9, information may be sent to 3^{rd} Party Tools or Services 100 (FIG. 1-100) via API 70 (FIG. 1-70) at X9 and then evaluation process ends at X10. If it is determined that the Approval Decision (FIG. 4-P13) received at X12 is a denial the privilege request process is ended at X13. Notification X14 may be sent to End User 10 (FIG. 1-10) and information may be sent to 3^{rd} Party Tools or Services 100 (FIG. 1-100) via API 70 (FIG. 1-70) at X9 with the evaluation process ending at X10.

FIG. 13 depicts an illustrative flow diagram of a sub-process on Local Agent Engine 14 (FIG. 1-14) for Out of Band (Offline) Approvals. In this embodiment, Local Agent Engine 14 (FIG. 1-14) has determined that the TID 15 (FIG. 1-15) is approved for elevation and that the Local Agent Engine 14 (FIG. 1-14) has an active operational mode previously set by the System Administrator 33 (FIG. 1-33) or Approver 32 (FIG. 1-32) for the Computer 16 (FIG. 1-16) of either Technician Mode (FIG. 11-W6) at Y1, or Live Mode (FIG. 3-V8) at Y2, and that Local Agent Engine 14 (FIG. 1-14) is unable to communicate with Cloud Services Engine 50 (FIG. 1-50). Information is presented to End User 10 (FIG. 1-10) querying the method End User 10 (FIG. 1-10) would like to use to initiate Approval of the privilege request at Y3. Examples of potential verification methods include either known or unknown methods of verification based on shared secrets such as Time-Based Code Y4, Voice Verified using PSTN network Y5, Scannable QR Code Verified by a Mobile Application Y6, SMS Messaging Y7, or other future unknown method Y8. The examples of potential shared secret verification methods are for illustrative example and not exhaustive or intended to be limiting. Information comprising the privilege request is queued up for transmission by Local Agent Engine 14 (FIG. 1-14) to Cloud Services Engine 50 (FIG. 1-50) at Y10. Local Agent Engine 14 (FIG. 1-14) determines if Out of Band verification code was successful at Y11. If verification code was not successful privilege request process ends at Y12. If verification code was successful, Local Agent Engine 14 (FIG. 1-14) determines which Trigger Handler to use (FIG. 12-X1) at Y13.

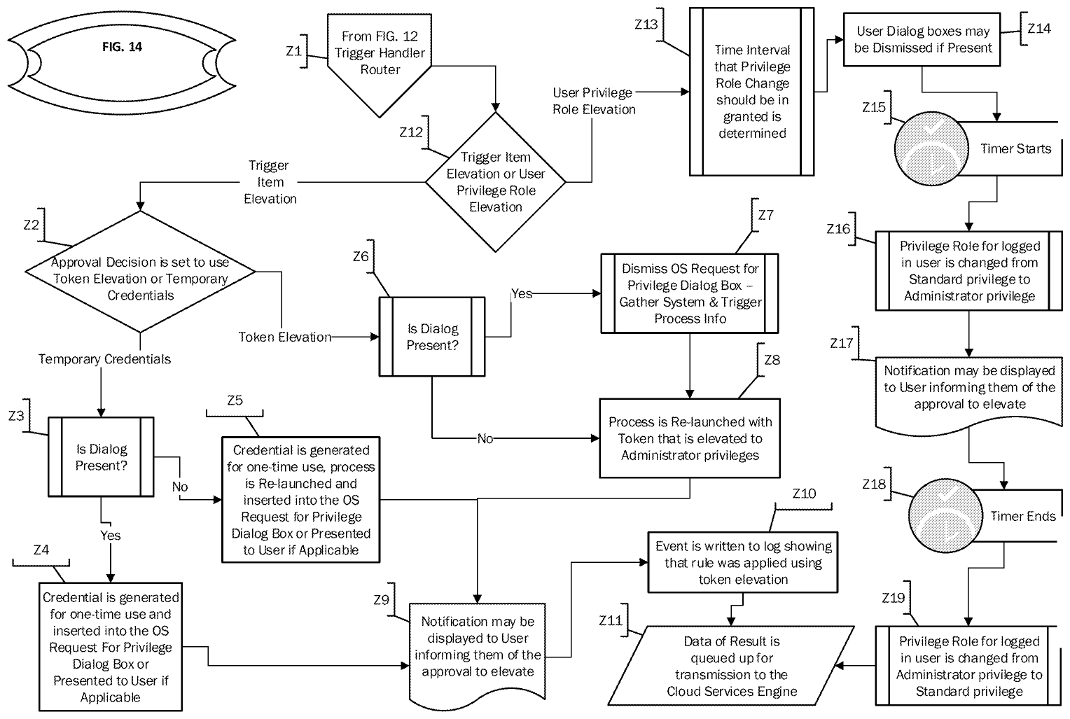

FIG. 14 depicts an illustrative flow diagram of a sub-process on Local Agent Engine 14 (FIG. 1-14) when a Trigger Identifier (TID) 15 has been processed which is identified by the Trigger Handler Routing (FIG. 12). In this embodiment the Local Agent Engine 14 (FIG. 1-14) has determined that the Trigger Type for the TID 15 (FIG. 1-15) is Operating System Request for Privilege (FIG. 12-X6) at Z1 and should have privileges elevated. Local Agent Engine 14 (FIG. 1-14) determines if the approval is to be elevated specifically for the Trigger Item or by changing the User Privilege Role at Z12.

If the approval is to be elevated by changing the User Privilege Role, Local Agent Engine 14 (FIG. 1-14) determines the time interval that the Privilege Role change should be granted for at Z13. If a user dialog box message is present on Computer 16 (FIG. 1-16) it may be dismissed by Local Agent Engine 14 (FIG. 1-14) at Z14. A timer is started at Z15 on Local Agent Engine 14 (FIG. 1-14) and on Cloud Services Engine 50 (FIG. 1-50). Local Agent Engine 14 (FIG. 1-14) changes the User Privilege Role to that of Administrator Z16. Depending on preferences of Approver 32 (FIG. 1-32), a dialog box may be presented to End User 10 (FIG. 1-10) which displays User Privilege Role change progress, approval information, and time remaining for the elevated User Privilege Role to be granted at Z17. Upon expiration of the timer at Z18 User Privilege Role is set back to the original level by the Local Agent Engine 14 (FIG. 1-14) at Z19. The result of how the rule was processed is queued up for transmission by Local Agent Engine 14 (FIG. 1-14) to Cloud Services Engine 50 (FIG. 1-50) at Z11.

If determination at Z12 is made showing that the approval is to be elevated specifically for the Trigger Item then Local Agent Engine 14 (FIG. 1-14) on Computer 16 (FIG. 1-16) determines if the matching rule is to be elevated using temporary credentials or by elevating the process token at Z2. If the matching rule is to be elevated using temporary credentials, Local Agent Engine 14 (FIG. 1-14) determines if the Privilege Restriction Event 12 (FIG. 1-12) is an Operating System Request for Privilege and a dialog box message is present on Computer 16 (FIG. 1-16) at Z3. If a dialog box is present, credentials are generated on Computer 16 (FIG. 1-16) and then inserted into the dialog box associated with OS Request for Privilege Dialog Box at Z4. Notification may be sent to End User 10 (FIG. 1-10) at Z9 of the approval to elevate and an event is written to a log for Computer 16 (FIG. 1-16) showing the rule was applied using temporary credentials at Z10. The result of how the rule was processed is queued up for transmission by Local Agent Engine 14 (FIG. 1-14) to Cloud Services Engine 50 (FIG. 1-50) at Z11.

If determination at Z2 is made showing that the matching rule is set to use process token elevation, the Local Agent Engine 14 (FIG. 1-14) determines if an Operating System Request for Privilege dialog box message is present on Computer 16 (FIG. 1-16) at Z6. If dialog box is present then OS Request for Privilege Dialog Box initiated by Trigger Item 11 (FIG. 1-11) is dismissed and additional information is gathered about Trigger Item 11 (FIG. 1-11), computer configuration, and other running processes of Computer 16 (FIG. 1-16) at Z7 and then Trigger Item 11 (FIG. 1-11) is re-launched with a token that is elevated to Administrator privileges at Z8. Notification may or may not be sent to End User 10 (FIG. 1-10) at Z9 of the approval to elevate as desired by Approver 32 (FIG. 1-32). An event is written to a log for Computer 16 (FIG. 1-16) showing the rule was applied using process token elevation at Z10.

The result of how the rule was processed is queued up for transmission by Local Agent Engine 14 (FIG. 1-14) to Cloud Services Engine 50 (FIG. 1-50) at Z11.

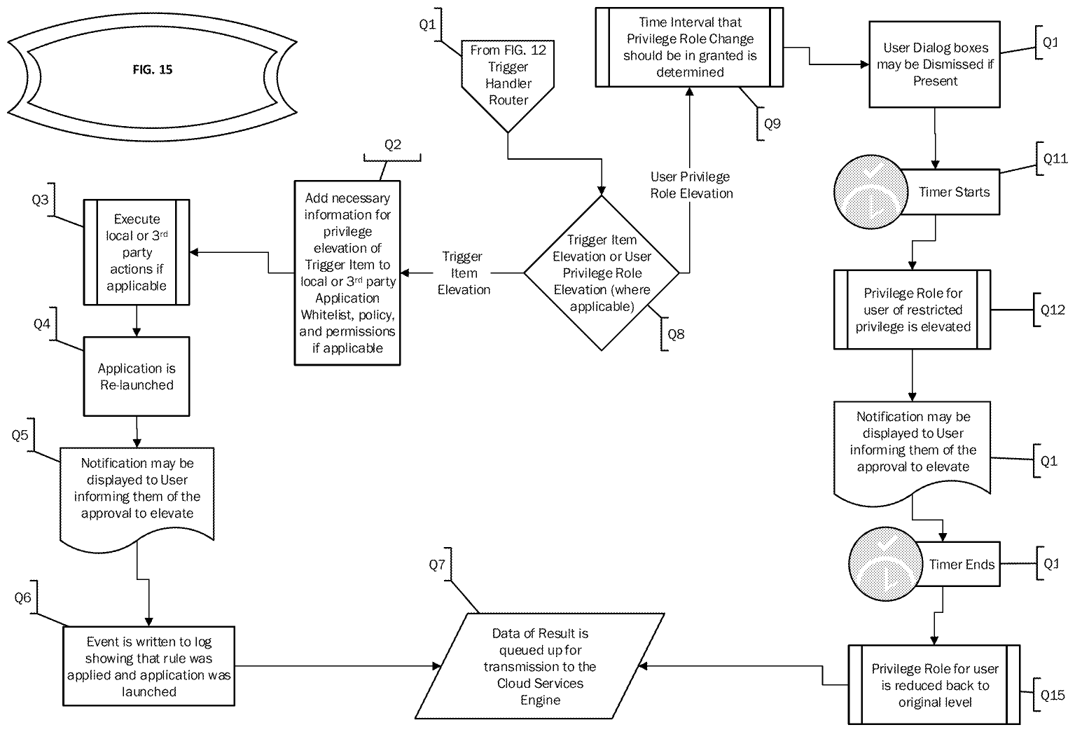

FIG. 15 depicts an illustrative flow diagram of a sub-process on Local Agent Engine 14 (FIG. 1-14) when a Trigger Identifier (TID) 15 (FIG. 1-15) has been processed which is identified by the Trigger Handler Routing (FIG. 12). In this embodiment the Local Agent Engine 14 (FIG. 1-14) has determined that the Trigger Type for the TID 15 (FIG. 1-15) is for an Application (FIG. 12-X7) at Q1 and should have privileges elevated. Local Agent Engine 14 (FIG. 1-14) determines if the approval is to be elevated specifically for the Trigger Item or by changing the User Privilege Role at Q8.

If the approval is to be elevated by changing the User Privilege Role, Local Agent Engine 14 (FIG. 1-14) determines the time interval that the Privilege Role change should be granted for at Q9. If a user dialog box message is present on Computer 16 (FIG. 1-16) it may be dismissed by Local Agent Engine 14 (FIG. 1-14) at Q10. A timer is started at Q11 on Local Agent Engine 14 (FIG. 1-14) and on Cloud Services Engine 50 (FIG. 1-50). Where applicable, Local Agent Engine 14 (FIG. 1-14) or Cloud Services Engine 50 (FIG. 1-50) changes the User Privilege Role for the application, service, or 3^{rd} Party Tools 100 (FIG. 1-100) either locally or via API 70 (FIG. 1-70) at Q12. Depending on preferences of Approver 32 (FIG. 1-32), a dialog box may be presented to End User 10 (FIG. 1-10) which displays User Privilege Role change progress, approval information, and time remaining for the elevated User Privilege Role to be granted at Q13. Upon expiration of the timer at Q14 User Privilege Role is set back to the original level by the Local Agent Engine 14 (FIG. 1-14) or Cloud Services Engine 50 (FIG. 1-50) via API 70 (FIG. 1-70) at Q15. The result of how the rule was processed is queued up for transmission by Local Agent Engine 14 (FIG. 1-14) to Cloud Services Engine 50 (FIG. 1-50) at Q7.

If determination at Q8 is made showing that the approval is to be elevated specifically for the Trigger Item then information may be sent to an application, service, or 3^{rd} Party Tools 100 (FIG. 1-100) either locally or via API 70 (FIG. 1-70) at Q2. Additional actions may be carried out by the Local Agent Engine 14 (FIG. 1-14) for the Application needing elevation using either Operating System or other 3^{rd} party tools. Trigger Item 11 (FIG. 1-11) is re-launched with elevated privileges at Q4. Notification may or may not be sent to End User 10 (FIG. 1-10) at Q5 of the approval to elevate as desired by Approver 32 (FIG. 1-32). An event is written to a log for Computer 16 (FIG. 1-16) showing the rule was applied and elevation occurred at Q6. The result of how the rule was processed is queued up for transmission by Local Agent Engine 14 (FIG. 1-14) to Cloud Services Engine 50 (FIG. 1-50) at Q7.

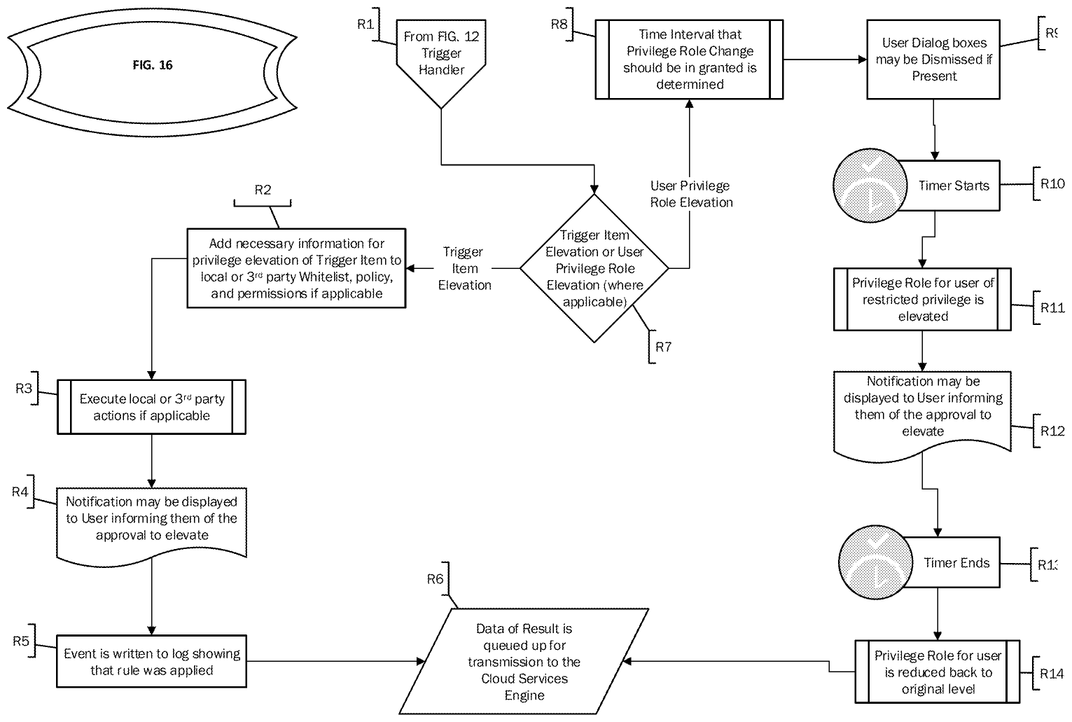

FIG. 16 depicts an illustrative flow diagram of a sub-process on Local Agent Engine 14 (FIG. 1-14) when a Trigger Identifier (TID) 15 (FIG. 1-15) has been processed is identified by the Trigger Handler Routing (FIG. 12) as a Trigger Type of something other than an Operating System Request or Application Request for Privilege. In this embodiment the Local Agent Engine 14 (FIG. 1-14) has determined that privileges should be elevated and that the TID 15 (FIG. 1-15) is for something other than an Operating System Request or Application Request for Privilege (FIG. 12-X8) R1 which may include, but not limited to, URL, UNC Permissions, Removable Media, or Device. The examples of potential Trigger Handlers may comprise additional handling routines for Trigger Types known or unknown and are not exhaustive or intended to be limiting. Local Agent Engine 14 (FIG. 1-14) determines if the approval is to be elevated specifically for the Trigger Item or when applicable by changing the User Privilege Role at R7.

If the approval is to be elevated by changing the User Privilege Role, Local Agent Engine 14 (FIG. 1-14) determines the time interval that the Privilege Role change should be granted for at R8. If a user dialog box message is present on Computer 16 (FIG. 1-16) it may be dismissed by Local Agent Engine 14 (FIG. 1-14) at R9. A timer is started at R10 on Local Agent Engine 14 (FIG. 1-14) and on Cloud Services Engine 50 (FIG. 1-50). Where applicable, Local Agent Engine 14 (FIG. 1-14) or Cloud Services Engine 50 (FIG. 1-50) changes the User Privilege Role for the application, service, or 3^{rd} Party Tools 100 (FIG. 1-100) either locally or via API 70 (FIG. 1-70) at R11. Depending on preferences of Approver 32 (FIG. 1-32), a dialog box may be presented to End User 10 (FIG. 1-10) which displays User Privilege Role change progress, approval information, and time remaining for the elevated User Privilege Role to be granted at R12. Upon expiration of the timer at R13 User Privilege Role is set back to the original level by the Local Agent Engine 14 (FIG. 1-14) or Cloud Services Engine 50 (FIG. 1-50) via API 70 (FIG. 1-70) at R14. The result of how the rule was processed is queued up for transmission by Local Agent Engine 14 (FIG. 1-14) to Cloud Services Engine 50 (FIG. 1-50) at R6.

If determination at R7 is made showing that the approval is to be elevated specifically for the Trigger Item then information may be sent to an application, service, or 3^{rd} Party Tools 100 (FIG. 1-100) either locally or via API 70 (FIG. 1-70) at R2. Additional actions may be carried out by the Local Agent Engine 14 (FIG. 1-14) for the TID 15 (FIG. 1-15) needing elevation using either Operating System or other 3^{rd} party tools and the Trigger Item 11 (FIG. 1-11) may be re-launched R3. Notification may or may not be sent to End User 10 (FIG. 1-10) at R4 of the approval to elevate as desired by Approver 32 (FIG. 1-32). An event is written to a log for Computer 16 (FIG. 1-16) showing the rule was applied and elevation occurred at R5. The result of how the rule was processed is queued up for transmission by Local Agent Engine 14 (FIG. 1-14) to Cloud Services Engine 50 (FIG. 1-50) at R6.

The foregoing description of various embodiments of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-enabled system for real-time escalation of user privileges and real-time creation of rules for managing requests for privilege on a computer resource, comprising:
one or more computers, each computer comprising a local agent engine, the local agent engine comprising processes that monitor each of the one or more computers for privilege elevation events, gather information pertaining to processes that trigger request for privilege dialog boxes, maintain information on configuration of each of the one or more computers, gather information from application and computer event logs, determine and assign trigger identifiers to trigger items, process rules by elevating privilege of approved processes or ending processes for rules that are denied, and communicate information to a user of the one or more computers;
a cloud services engine comprising a plurality of common resources, the plurality of common resources comprising an application programming interface (API), a database, data storage, and web services and logic, artificial intelligence (AI), recommendations from other 3^{rd} party resources, and computational resources for processing and presenting information, rules and logic;
an approver notification interface; and
a system administrator configuration portal,
wherein the cloud services engine communicates via the API with the local agent engine, approver notification interface, and the system administrator configuration,
where further a master list of privilege elevation rules is stored in the database of the cloud services engine,
wherein the system administrator configuration portal is used by a system administrator to configure predetermined rules regarding elevation of privileges,
wherein the administrator configuration portal is implemented as an application on a mobile device, a web application, a website, or an application running on wearable technology, wherein further the administrator configuration portal is used by a system administrator to examine, create and process in real-time requests for privilege elevation by a user of a computer.

2. The computer-enabled system of claim 1, wherein the computers are organized into a local organization unit.

3. The computer-enabled system of claim 2, wherein the local organization unit comprises a location, a company or a managing entity.

4. The computer-enabled system of claim 1, wherein the plurality of common resources on the cloud services engine are distributed over different systems and networks.

5. A method of real-time escalation of user privileges for at least one computer resource implemented by at least one computing device, comprising:
determining by a local agent engine on at least one computer the presence of a request for privilege by a user of the at least one computer;
determining a triggering process that triggered the request for privilege and assigning a unique trigger identifier for the triggering process; and
consulting a stored set of rules in at least one computer database that relate to the unique trigger identifier,
wherein if a rule is located that is related to the unique trigger identifier that regards the elevation of privileges on the at least one computer associated with the triggering process, thereafter applying the rule,
wherein if no rule is located in the at least one computer database that is related to the unique trigger identifier that regards the elevation of privileges on the at least one computer associated with the triggering process, thereafter submitting a requesting from a remote cloud services engine via an application programming interface (API) for elevation of privilege on the at least one computer, wherein the cloud services engine communicates a stored set of rules to the at least one computer, wherein if the communicated set of stored rules includes a rule regarding elevation of privileges associated with the triggering process that is related to the unique trigger identifier, thereafter applying the rule, wherein if the communicated stored set of rules does not include a rule regarding elevation of privileges associated with the triggering process that is related to the unique trigger identifier, a request is communicated from the cloud services engine to a system administrator portal and approver notification interface for evaluation of the request for privilege elevation on the at least one computer,
wherein the result of the evaluation of the request for privilege is thereafter transmitted to the at least one computer, wherein if the request for privilege is approved, the triggering process is specifically permitted to be executed or the user of the at least one computer is granted an increased level of privilege which then would allow execution of the triggering process on the at least one computer, wherein if the request for privilege is denied, the triggering process is not permitted to be executed on the at least one computer.
The method of real-time escalation of user privileges for at least one computer resource implemented by at least one computing device of claim 5, wherein the presence of the request for privilege by the user of the at least one computer comprises the presence of a dialog box, information gathered from an application operating on the at least one computer, the operating system event log of the at least one computer, API information pertaining to the at least one computer via API, or other processing or combination of processes running on the at least one computer that indicates that privilege on the at least one computer has been restricted.

6. The method of real-time escalation of user privileges for at least one computer resource implemented by at least one computing device of claim 5, wherein the request for privilege relates to the operating system of the at least one computer, an application running on the least one computer, a website accessed by a browser that is running on the at least one computer, access to a device in communication with the at least one computer, or combinations thereof.

7. The method of real-time escalation of user privileges for at least one computer resource implemented by at least one computing device of claim 5, wherein the result of the evaluation of the request for privilege is communicated to one or more third party systems via API.

8. The method of real-time escalation of user privileges for at least one computer resource implemented by at least one computing device of claim 8, wherein the result of the request for privilege is used by the one or more third party systems for purposes of ticketing, tracking, and billing.

9. The method of real-time escalation of user privileges for at least one computer resource implemented by at least one computing device of claim 5, wherein the result of the evaluation for request for privilege is stored in at least one computer database as a rule that is related to the unique trigger identifier.

10. A computer program product for managing user privileges for computer resources, the computer program product comprising program instructions stored on computer readable storage media, which when executed cause a computer to:
determine by a local agent engine on at least one computer the presence of a request for privilege by a user of the at least one computer;
determine a triggering process that triggered the request for privilege and assigning a unique trigger identifier for the triggering process; and
consult a stored set of rules in at least one computer database that relate to the unique trigger identifier,
wherein if a rule is located that is related to the unique trigger identifier that regards the elevation of privileges on the at least one computer associated with the triggering process, thereafter apply the rule,
wherein if no rule is located in the at least one computer database that is related to the unique trigger identifier that regards the elevation of privileges on the at least one computer associated with the triggering process, thereafter submit a requesting from a remote cloud services engine via an application programming interface (API) for elevation of privilege on the at least one computer, wherein the cloud services engine communicates a stored set of rules to the at least one computer, wherein if the communicated set of stored rules includes a rule regarding elevation of privileges associated with the triggering process that is related to the unique trigger identifier, thereafter apply the rule, wherein if the communicated stored set of rules does not include a rule regarding elevation of privileges associated with the triggering process that is related to the unique trigger identifier, communicate a request from the cloud services engine to a system administrator portal and approver notification interface for evaluation of the request for privilege elevation on the at least one computer,
thereafter receive the result of the evaluation of the request for privilege by the at least one computer, wherein if the request for privilege is approved, the triggering process is specifically permitted to be executed or the user of the at least one computer is granted an increased level of privilege which then would allow execution of the triggering process on the at least one computer, wherein if the request for privilege is denied, the triggering process is not permitted to be executed on the at least one computer.

11. A method for deploying a system for managing user privileges for computer resources, comprising:
providing a computer infrastructure being operable to:
determine by a local agent engine on at least one computer the presence of a request for privilege by a user of the at least one computer;
determine a triggering process that triggered the request for privilege and assigning a unique trigger identifier for the triggering process; and
consult a stored set of rules in at least one computer database that relate to the unique trigger identifier,
wherein if a rule is located that is related to the unique trigger identifier that regards the elevation of privileges on the at least one computer associated with the triggering process, thereafter apply the rule,
wherein if no rule is located in the at least one computer database that is related to the unique trigger identifier that regards the elevation of privileges on the at least one computer associated with the triggering process, thereafter submit a requesting from a remote cloud services engine via an application programming interface (API) for elevation of privilege on the at least one computer, wherein the cloud services engine communicates a stored set of rules to the at least one computer, wherein if the communicated set of stored rules includes a rule regarding elevation of privileges associated with the triggering process that is related to the unique trigger identifier, thereafter apply the rule, wherein if the communicated stored set of rules does not include a rule regarding elevation of privileges associated with the triggering process that is related to the unique trigger identifier, communicate a request from the cloud services engine to a system administrator portal and approver notification interface for evaluation of the request for privilege elevation on the at least one computer,
thereafter receive the result of the evaluation of the request for privilege by the at least one computer, wherein if the request for privilege is approved, the triggering process is specifically permitted to be executed or the user of the at least one computer is granted an increased level of privilege which then would allow execution of the triggering process on the at least one computer, wherein if the request for privilege is denied, the triggering process is not permitted to be executed on the at least one computer.
